(19) United States
(12) Patent Application Publication
(10) Pub. No.: US 2025/0185009 A1
(43) Pub. Date: Jun. 5, 2025

(54) MANAGEMENT OF UPLINK MULTIPLEXING IN A WIRELESS COMMUNICATIONS SYSTEM

(71) Applicant: QUALCOMM Incorporated, San Diego, CA (US)

(72) Inventors: Yi HUANG, San Diego, CA (US); Jing SUN, San Diego, CA (US); Mostafa KHOSHNEVISAN, San Diego, CA (US)

(21) Appl. No.: 18/528,576

(22) Filed: Dec. 4, 2023

(51) Int. Cl. H04W 72/21; H04W 72/1268; H04W 72/563

(52) U.S. Cl. CPC H04W 72/21; H04W 72/1268; H04W 72/563

(57) ABSTRACT

Methods, systems, and devices for wireless communication are described. A user equipment (UE) may receive a control message that is associated with an uplink control channel and that indicates a priority level associated with an uplink data channel. The UE may multiplex uplink control information associated with the uplink control channel with data associated with the uplink data channel based on the priority level being associated with the uplink data channel. The UE may then transmit the uplink control information multiplexed with the data in the uplink data channel.

### FIELD OF TECHNOLOGY

The following relates to wireless communication, including management of uplink multiplexing in a wireless communications system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may be associated with uplink channels that overlap in time. Techniques for managing overlapping uplink channels may be desired.

### SUMMARY

The described techniques relate to improved methods, systems, devices, and apparatuses that support management of uplink multiplexing in a wireless communications system. For example, the described techniques provide for a signaling mechanism that indicates one or more uplink data channels for multiplexing with one or more uplink control channels. As part of configuring or scheduling an uplink control channel at a user equipment (UE), a network entity may provide a priority level that the UE uses as a basis for selecting one or more uplink data channels for multiplexing with the uplink control channel. For instance, the UE may select for multiplexing the uplink data channel(s) that are associated with priority levels equal to the priority level provided by the network entity.

A method for wireless communications by a UE is described. The method may include receiving a control message that is associated with an uplink control channel and that indicates a priority level associated with an uplink data channel, multiplexing uplink control information associated with the uplink control channel with data associated with the uplink data channel based on the priority level being associated with the uplink data channel, and transmitting the uplink control information multiplexed with the data in the uplink data channel.

An apparatus for wireless communications is described. The apparatus may include at least one processor and at least one memory coupled with the at least one processor, with instructions stored in the at least one memory, the instructions being executable by the at least one processor, individually or in any combination, to cause the apparatus to receive a control message that is associated with an uplink control channel and that indicates a priority level associated with an uplink data channel, multiplex uplink control information associated with the uplink control channel with data associated with the uplink data channel based on the priority level being associated with the uplink data channel, and transmit the uplink control information multiplexed with the data in the uplink data channel.

Another UE for wireless communications is described. The UE may include means for receiving a control message that is associated with an uplink control channel and that indicates a priority level associated with an uplink data channel, means for multiplexing uplink control information associated with the uplink control channel with data associated with the uplink data channel based on the priority level being associated with the uplink data channel, and means for transmitting the uplink control information multiplexed with the data in the uplink data channel.

A non-transitory computer-readable medium storing code for wireless communications is described. The code may include instructions executable by one or more processors to receive a control message that is associated with an uplink control channel and that indicates a priority level associated with an uplink data channel, multiplex uplink control information associated with the uplink control channel with data associated with the uplink data channel based on the priority level being associated with the uplink data channel, and transmit the uplink control information multiplexed with the data in the uplink data channel.

Some examples of the method, UEs, and non-transitory computer-readable medium described herein may further include operations, features, means, or instructions for receiving an indication of a priority level assigned to the uplink data channel, where the uplink control information may be multiplexed with the data associated with the uplink data channel based on the priority level indicated by the control message matching the priority level assigned to the uplink data channel.

Some examples of the method, UEs, and non-transitory computer-readable medium described herein may further include operations, features, means, or instructions for multiplexing a copy of the uplink control information with second data associated with a second uplink data channel based on the second uplink data channel being associated with the priority level and transmitting the copy of the uplink control information multiplexed with the second data in the second uplink data channel.

In some examples of the method, UEs, and non-transitory computer-readable medium described herein, the control message indicates a second priority level associated with a second uplink data channel and the method, apparatuses, and non-transitory computer-readable medium may include further operations, features, means, or instructions for multiplexing a copy of the uplink control information with second data associated with the second uplink data channel based on the second priority level being associated with the second uplink data channel and transmitting the copy of the uplink control information multiplexed with the second data in the second uplink data channel.

Some examples of the method, UEs, and non-transitory computer-readable medium described herein may further include operations, features, means, or instructions for receiving a second control message that may be associated with a second uplink control channel and that indicates the priority level and multiplexing, based on the control message and the second control message indicating the same priority level, the uplink control information associated with the uplink control channel with second uplink control information associated with the second uplink control channel, where multiplexing the uplink control information with the data includes multiplexing the second uplink control information with the data.

In some examples of the method, UEs, and non-transitory computer-readable medium described herein, the priority level may be a priority level assigned to the uplink data channel and the uplink control information may be multiplexed with the data associated with the uplink data channel based on the priority level being the priority level assigned to the uplink data channel.

In some examples of the method, UEs, and non-transitory computer-readable medium described herein, the priority level includes a priority level assigned to the uplink control channel and the uplink control information may be multiplexed with the data associated with the uplink data channel based on the priority level assigned to the uplink control channel matching a priority level assigned to the uplink data channel.

Some examples of the method, UEs, and non-transitory computer-readable medium described herein may further include operations, features, means, or instructions for determining a set of uplink data channels that overlap in time with the uplink control channel and selecting the uplink data channel for multiplexing the uplink control information based on the uplink data channel being included in the set of uplink data channels.

In some examples of the method, UEs, and non-transitory computer-readable medium described herein, the control message includes a radio resource control (RRC) message that configures the uplink control channel or includes a downlink uplink control information (DCI) message that schedules the uplink control channel.

A method for wireless communications by a network entity is described. The method may include outputting a control message that is associated with an uplink control channel and that indicates a priority level associated with an uplink data channel, obtaining, in the uplink data channel based on the priority level being associated with the uplink data channel, uplink control information that is associated with the uplink control channel and that is multiplexed with data associated with the uplink data channel, and decoding the uplink control information based on receiving the uplink control information multiplexed with the data.

An apparatus for wireless communications is described. The apparatus may include at least one processor and at least one memory coupled with the at least one processor, with instructions stored in the at least one memory, the instructions being executable by the at least one processor, individually or in any combination, to cause the apparatus to output a control message that is associated with an uplink control channel and that indicates a priority level associated with an uplink data channel, obtain, in the uplink data channel based on the priority level being associated with the uplink data channel, uplink control information that is associated with the uplink control channel and that is multiplexed with data associated with the uplink data channel, and decode the uplink control information based on receiving the uplink control information multiplexed with the data.

Another network entity for wireless communications is described. The network entity may include means for outputting a control message that is associated with an uplink control channel and that indicates a priority level associated with an uplink data channel, means for obtaining, in the uplink data channel based on the priority level being associated with the uplink data channel, uplink control information that is associated with the uplink control channel and that is multiplexed with data associated with the uplink data channel, and means for decoding the uplink control information based on receiving the uplink control information multiplexed with the data.

A non-transitory computer-readable medium storing code for wireless communications is described. The code may include instructions executable by one or more processors to output a control message that is associated with an uplink control channel and that indicates a priority level associated with an uplink data channel, obtain, in the uplink data channel based on the priority level being associated with the uplink data channel, uplink control information that is associated with the uplink control channel and that is multiplexed with data associated with the uplink data channel, and decode the uplink control information based on receiving the uplink control information multiplexed with the data.

Some examples of the method, network entities, and non-transitory computer-readable medium described herein may further include operations, features, means, or instructions for outputting an indication of a priority level assigned to the uplink data channel, where the uplink control information may be received in the uplink data channel based on the priority level indicated by the control message matching the priority level assigned to the uplink data channel.

Some examples of the method, network entities, and non-transitory computer-readable medium described herein may further include operations, features, means, or instructions for obtaining, in a second uplink data channel based on the second uplink data channel being associated with the priority level, a copy of the uplink control information multiplexed with second data.

In some examples of the method, network entities, and non-transitory computer-readable medium described herein, the control message indicates a second priority level and the method, apparatuses, and non-transitory computer-readable medium may include further operations, features, means, or instructions for obtaining, in a second uplink data channel based on the second priority level being associated with the second uplink data channel, a copy of the uplink control information that may be multiplexed with second uplink data associated with the second uplink data channel.

Some examples of the method, network entities, and non-transitory computer-readable medium described herein may further include operations, features, means, or instructions for combining the uplink control information with the copy of the uplink control information, where decoding the uplink control information includes decoding the combination of the uplink control information and the copy of the uplink control information.

Some examples of the method, network entities, and non-transitory computer-readable medium described herein may further include operations, features, means, or instructions for outputting a second control message that may be associated with a second uplink control channel and that indicates the priority level and obtaining, based on the control message and the second control message indicating the same priority level, the uplink control information multiplexed with second uplink control information that may be associated with the second uplink control channel.

In some examples of the method, network entities, and non-transitory computer-readable medium described herein, the priority level may be a priority level assigned to the uplink data channel and the uplink control information may be received in the uplink data channel based on the priority level being the priority level assigned to the uplink data channel.

In some examples of the method, network entities, and non-transitory computer-readable medium described herein, the priority level includes a priority level assigned to the uplink control channel and the uplink control information may be received in the uplink data channel based on the priority level assigned to the uplink control channel matching a priority level assigned to the uplink data channel.

In some examples of the method, network entities, and non-transitory computer-readable medium described herein, the control message includes an RRC message that configures the uplink control channel or includes a downlink uplink control information (DCI) message that schedules the uplink control channel.

### BRIEF DESCRIPTION OF THE DRAWINGS

FIG. 1 shows an example of a wireless communications system that supports management of uplink multiplexing in a wireless communications system in accordance with one or more aspects of the present disclosure.

FIG. 2 shows an example of a wireless communications system that supports management of uplink multiplexing in a wireless communications system in accordance with one or more aspects of the present disclosure.

FIG. 3 shows an example of communication resources that support management of uplink multiplexing in a wireless communications system in accordance with one or more aspects of the present disclosure.

FIG. 4 shows an example of a process flow that supports management of uplink multiplexing in a wireless communications system in accordance with one or more aspects of the present disclosure.

FIG. 5 shows an example of a process flow that supports management of uplink multiplexing in a wireless communications system in accordance with one or more aspects of the present disclosure.

FIGS. 6 and 7 show block diagrams of devices that support management of uplink multiplexing in a wireless communications system in accordance with one or more aspects of the present disclosure.

FIG. 8 shows a block diagram of a communications manager that supports management of uplink multiplexing in a wireless communications system in accordance with one or more aspects of the present disclosure.

FIG. 9 shows a diagram of a system including a device that supports management of uplink multiplexing in a wireless communications system in accordance with one or more aspects of the present disclosure.

FIGS. 10 and 11 show block diagrams of devices that support management of uplink multiplexing in a wireless communications system in accordance with one or more aspects of the present disclosure.

FIG. 12 shows a block diagram of a communications manager that supports management of uplink multiplexing in a wireless communications system in accordance with one or more aspects of the present disclosure.

FIG. 13 shows a diagram of a system including a device that supports management of uplink multiplexing in a wireless communications system in accordance with one or more aspects of the present disclosure.

FIGS. 14 and 15 show flowcharts illustrating methods that support management of uplink multiplexing in a wireless communications system in accordance with one or more aspects of the present disclosure.

### DETAILED DESCRIPTION

A user equipment (UE) may use an uplink control channel to convey uplink control information to a network entity and may use an uplink data channel to convey data to the network entity. If an uplink control channel overlaps in time with an uplink data channel, a scenario referred to as a cross-channel conflict, the UE may multiplex the uplink control information associated with the uplink control channel with the data associated with the uplink data channel so that the UE can transmit both the control information and the data in the uplink data channel. But if there are multiple candidate uplink data channels for multiplexing, the UE may not know which uplink data channel to select for multiplexing, or the UE may perform a rule-based selection procedure that consumes excessive resources (e.g., time resources, processing resources).

According to the techniques described herein, a UE that detects a cross-channel conflict between an uplink control channel and an uplink data channel may select an uplink data channel for multiplexing based on a priority level indicated to the UE, which may allow the UE to avoid a resource-consuming selection process. For example, the control message that configures or schedules the uplink control channel may indicate a priority level that is associated with the uplink data channel that the UE is to use for multiplexing. Accordingly, the UE may multiplex uplink control information associated with the uplink control channel with the data associated with the uplink data channel indicated by the priority level. The UE may then transmit the multiplexed uplink control information and the data in the uplink data channel.

Aspects of the disclosure are initially described in the context of wireless communications systems. Additional aspects of the disclosure are described in the context of communication resources and process flows. Aspects of the disclosure are further illustrated by and described with reference to apparatus diagrams, system diagrams, and flowcharts that relate to management of uplink multiplexing in a wireless communications system.

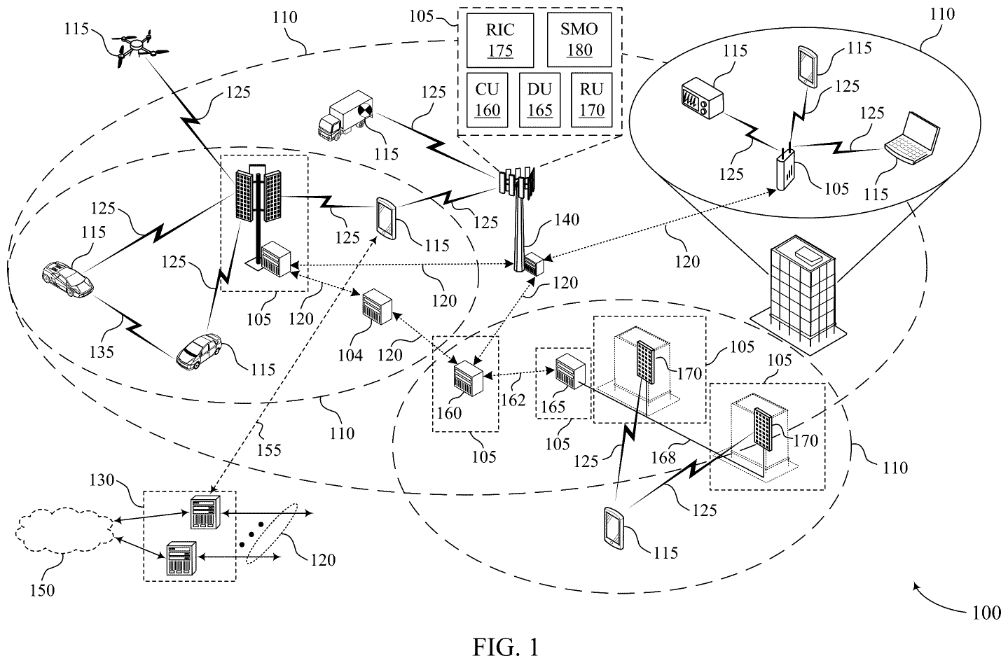

FIG. 1 shows an example of a wireless communications system 100 that supports management of uplink multiplexing in a wireless communications system in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support management of uplink multiplexing in a wireless communications system as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may have a cross-channel conflict in that the UE 115 is configured or scheduled with an uplink control channel (e.g., a physical uplink control channel (PUCCH)) that overlaps in time with one or more uplink data channels (e.g., physical uplink shared channels (PUSCHs)). In such a scenario, the UE 115 may refrain from transmitting the uplink control information (associated with the uplink control channel) in the uplink control channel and may instead multiplex the uplink control information with data for transmission in an uplink data channel. The UE 115 may select the uplink data channel for multiplexing (which may be referred to as the destination or target uplink data channel) based on a priority level that is associated with the uplink data channel and that is indicated to the UE 115 by a network entity 105. Multiplexing information associated with a first channel, such as an uplink control channel, with information associated with a second channel, such as an uplink data channel, for transmission over the second channel may be referred to as cross-channel multiplexing.

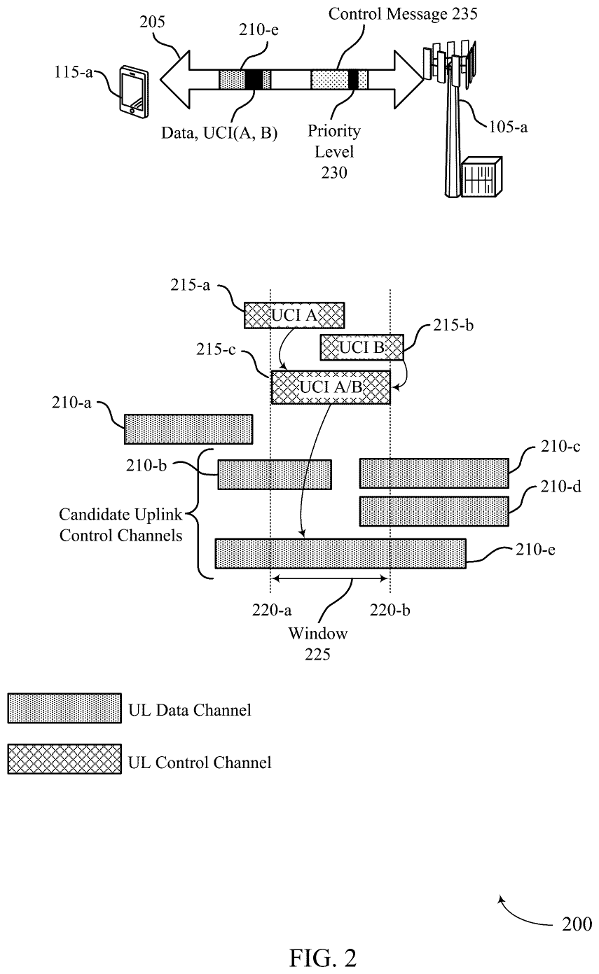

FIG. 2 shows an example of a wireless communications system 200 that supports management of uplink multiplexing in a wireless communications system in accordance with one or more aspects of the present disclosure. The wireless communications system 200 may be an example of the wireless communications system 100 and may include a UE 115-a and a network entity 105-a. The UE 115-a may communicate with the network entity 105-a over communications link 205, which may support uplink communications and downlink communications. To simplify the selection process for destination uplink data channels, the network entity 105-a may indicate an uplink data channel for cross-channel multiplexing by providing an indication of a priority level associated with the uplink data channel.

The UE 115-a may be configured or scheduled with multiple uplink data channels 210 (e.g., PUSCHs), which may be associated with one or more component carriers (CCs) or cells. For instance, the UE 115-a may be configured or scheduled with uplink (UL) data channel 210-a, which may be associated with component carrier 1 (CC1), uplink data channel 210-b and uplink data channel 210-c, each of which may be associated with component carrier 2 (CC2), uplink data channel 210-d, which may be associated with component carrier 3 (CC3), and uplink data channel 210-e, which may be associated with component carrier 4 (CC4). An uplink data channel may refer to an uplink channel that is scheduled or configured for conveying data.

The UE 115-a may be capable of transmitting uplink data channels associated with different component carriers concurrently (e.g., at the same or overlapping times). However, the UE 115-a may not be able to transmit an uplink control channel 215 concurrently with an uplink data channel 210 (or another uplink control channel 215), even if the two channels are associated with the same component carrier.

In some cases, the UE 115-a may be configured or scheduled with one or more uplink control channels 215 (e.g., PUCCHs) that overlap in time (e.g., conflict with) one or more uplink data channels 210. For example, the UE 115-a may be configured or scheduled with uplink control channel 215-a and uplink control channel 215-b. Uplink control channel 215-a may be associated with a first set of uplink control information (UCI) referred to as UCI A and uplink control channel 215-b may be associated with a second set of uplink control information referred to as UCI B.

An uplink control channel may refer to an uplink channel that is scheduled or configured for conveying uplink control information. Examples of uplink control information include HARQ feedback (e.g., HARQ acknowledgement (HARQ-ACK) information, HARQ non-acknowledgment (HARQ-NACK) information) and channel state information (CSI). Information associated with a channel may refer to information that is, at least initially, intended for (e.g., configured for, scheduled for, pending for) transmission over that channel.

In some examples, the UE 115-a may multiplex the UCI from two or more uplink control channels before performing cross-channel multiplexing with an uplink data channel. For instance, based on the uplink control channels 215 overlapping in time, the UE 115-a may multiplex the UCI A and the UCI B for transmission over uplink control channel 215-c. The multiplexed UCI may be referred to henceforth as UCI (A, B). The communication resources (e.g., time resources, frequency resources) of the uplink control channel 215-c may be determined by the UE 115-a based on the sizes of the UCI A and the UCI B, among other factors. In some examples, the multiplexing of the UCI associated with overlapping uplink control channels 215 may be conditioned on the uplink control channels 215 being associated with the same priority level. For case of reference multiplexing information from different channels may also be referred to as multiplexing those channels.

The UE 115-a may determine a set of candidate uplink data channels 210 for cross-channel multiplexing with the uplink control channel 215-c. The UE 115-a may determine the set of candidate uplink data channels 210 based on one or more boundaries 220 (e.g., temporal boundaries) associated with the uplink control channel 215-c. For example, the UE 115-a may select for inclusion in the set of candidate uplink data channels 210 any uplink data channel 210 that has one or more resources within the window 225, which may be defined by the boundary 220-a and the boundary 220-b.

Thus, the UE 115-a may determine that the set of candidate uplink data channels 210 includes all of the illustrated uplink data channels 210 except for uplink data channel 210-a. In some examples, the boundary 220-a may be based on (e.g., align with) the lead (e.g., temporally first) resource of the uplink control channel 215-c and the boundary 220-b may be based on (e.g., align with) the tail (e.g., temporally last) resource of the uplink control channel 215-c. However, other boundaries are contemplated and within the scope of the present disclosure.

After determining the set of candidate uplink control channels 210, the UE 115-a may select an uplink control channel 210 from the set of candidate uplink control channels 210 for cross-channel multiplexing. For example, the UE 115-a may select the uplink control channel 210-e for cross-channel multiplexing. The UE 115-a may select the uplink control channel 210-e based on the uplink control channel 210-e being associated with the priority level 230 indicated by the network entity 105-a. The priority level 230 may be indicated in a control message 235 (e.g., a DCI message, an RRC message) that is associated with (e.g., schedules, configures) the uplink control channel 215-a, the uplink control channel 215-b, or both. The control message 235 may be conveyed in a downlink control channel (e.g., a physical downlink control channel (PDCCH)).

Based on selecting the uplink data channel 210-e, the UE 115-a may multiplex the uplink control information (e.g., UCI (A, B)) associated with the uplink control channel 215-c with the data associated with the uplink data associated with the uplink data channel 210-c. Multiplexing first information and second information may refer to the process of combining the first information and the second information for transmission over the same communication resources. The UE 115-a may then transmit the multiplexed information (e.g., UCI (A, B) and the uplink data associated with the uplink data channel 210-e) in the uplink data channel 210-c. The UE 115-a may refrain from transmitting in the uplink control channel 215-c.

Although described with reference to multiplexing the uplink control channel 215-a with the uplink control channel 215-b, in some examples (if the uplink control channel 215-a and the uplink control channel 215-b are associated with different priority levels) the UE 115-a may not multiplex the uplink control channel 215-a with the uplink control channel 215-b. Further, the UE 115-a may select different uplink data channels 210 for multiplexing with the uplink control channel 215-a and the uplink control channel 215-b. For instance, if the uplink control channel 215-a is associated with priority level 1, the UE 115-a may select for multiplexing with the uplink control channel 215-a the uplink data channel 210 that is also associated with priority level 1. And if the uplink control channel 215-b is associated with priority level 2, the UE 115-a may select for multiplexing with the uplink control channel 215-b the uplink data channel 210 that is also associated with priority level 2.

Thus, the UE 115-a may select a destination uplink data channel 210 for cross-channel multiplexing with an uplink control channel 215 based on a network entity-indicated priority level associated with the uplink control channel 215.

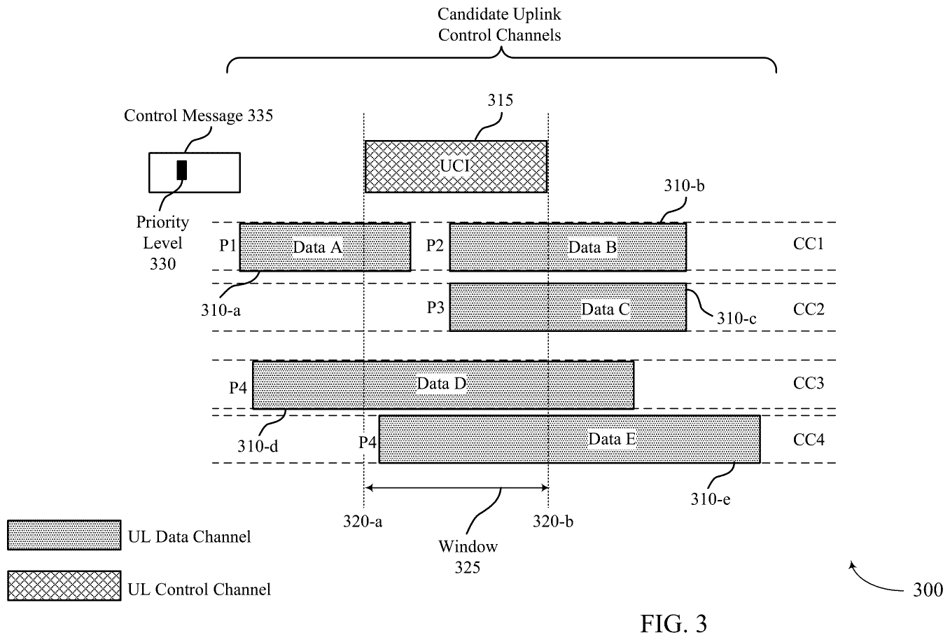

FIG. 3 shows an example of communication resources 300 that support management of uplink multiplexing in a wireless communications system in accordance with one or more aspects of the present disclosure. The communication resources 300 may include: a downlink control channel (e.g., a PDCCH, not shown) that conveys control message 335, an uplink control channel 315 (e.g., a PUCCH), and uplink data channels 310 (e.g., PUSCHs). The communication resources 300 may be an example of communication resources used by a UE 115 and a network entity 105. According to the techniques described herein, the network entity 105 may indicate a priority level 330 to the UE 115 so that the UE 115 can use the priority level 330 as a basis for selecting a destination uplink data channel for cross-channel multiplexing.

The uplink data channels 310 may be associated with (e.g., configured for, scheduled for) the UE and may be assigned respective priority levels. The uplink data channels 310 may also have respective associated data and may be associated with respective component carriers. For example, the uplink data channel 310-a may be assigned priority level 1 (P1), have associated data A, and be associated with component carrier 1 (CC1). The uplink data channel 310-b may be assigned priority level 2 (P2), have associated data B, and be associated with component carrier 1 (CC1). The uplink data channel 310-c may be assigned priority level 3 (P3), have associated data C, and be associated with component carrier 2 (CC). The uplink data channel 310-d may be assigned priority level 4 (P4), have associated data D, and be associated with component carrier 3 (CC3). And the uplink data channel 310-e may be assigned priority level 4 (P4), have associated data E, and be associated with component carrier 4 (CC4).

The uplink control channel 315 may be associated with (e.g., configured by, scheduled by) the control message 335, which may be an RRC message or DCI message. The control message 335 may indicate a priority level 330 that the UE 115 uses as a basis to select an uplink data channel 310 for cross-channel multiplexing. In a first example, the priority level 330 may represent the priority level assigned to an uplink data channel 310. In a second example, the priority level 330 may represent the priority level assigned to the uplink control channel 315. In either example, the UE 115 may select the uplink data channel 310 for cross-channel multiplexing based on the priority level of the uplink data channel 310 matching (e.g., having the same value as, being equal to) the priority level 330.

The UE 115 may determine that the uplink control channel 315 conflicts with one or more of the uplink data channels 310 and, accordingly, may determine to perform cross-channel multiplexing between the uplink control channel 315 and one or more of the uplink data channels 310.

The UE 115 may condition selection of an uplink data channel 310 for cross-channel multiplexing on 1) the uplink data channel 310 being included in the set of candidate uplink data channels 310, 2) the uplink data channel 310 being associated with the priority level 330 indicated for the uplink control channel 315, or both. The candidate uplink data channels 310 may include the uplink data channels 310 with resources that occur in the window 325, which may be defined by boundary 320-a and boundary 320-b. The boundary 320-a may be based on the lead (e.g., temporally first) resource of the uplink control channel 315 and the boundary 320-b may be based on the tail (e.g., temporally last) resource of the uplink control channel 315. Thus, the window 325 may be based on the duration of the uplink control channel 315.

As an example of selecting an uplink data channel 310 for cross-channel multiplexing, if the priority level 330 indicates that the uplink control channel 315 is associated with priority level 1, the UE 115 may select uplink data channel 310-a for cross-channel multiplexing based on 1) the uplink data channel 310-a being included in the set of candidate uplink data channels 310 and 2) the uplink data channel 310-a having an assigned priority level (e.g., priority level P1) that matches (e.g., is equal to) the priority level 330. Accordingly, the UE 115 may multiplex the UCI of the uplink control channel 315 with data A of the uplink data channel 310-a for transmission in the uplink data channel 310-a.

In some examples, there may be multiple uplink data channels 310 with priority levels that match the priority level 330. In such examples, the UE 115 may transmit multiple copies of the UCI using the multiple uplink data channels 310 that have matching priority levels. For instance, if the priority level 330 indicates that the uplink control channel 315 is associated with priority level 4, the UE 115 may multiplex a first copy of the UCI with data D and transmit the multiplexed information (e.g., the first copy of the UCI and data D) in the uplink data channel 310-d (e.g., because uplink data channel 310-d is assigned priority level P4). The UE 115 may also multiplex a second copy of the UCI with data E and transmit the multiplexed information (e.g., the second copy of the UCI and data E) in the uplink data channel 310-e (e.g., because uplink data channel 310-e is also assigned priority level P4).

In some examples, the control message 335 may indicate multiple priority levels that are associated with the uplink control channel 315. For example, the control message 335 may indicate a first priority level (e.g., priority level 330) and a second priority level (not shown). In such examples, the UE 115 may transmit multiple copies of the UCI using the multiple uplink data channels 310 that have different priority levels. For instance, if the first priority level (e.g., priority level 330) is priority level P2 and the second priority level is priority level P3, the UE 115 may multiplex a first copy of the UCI with data B and transmit the multiplexed information (e.g., the first copy of the UCI and data B) in the uplink data channel 310-b (e.g., because uplink data channel 310-b is assigned priority level P2). The UE 115 may also multiplex a second copy of the UCI with data C and transmit the multiplexed information (e.g., the second copy of the UCI and data C) in the uplink data channel 310-c (e.g., because uplink data channel 310-c is assigned priority level P3).

In some examples, the resources of the uplink control channel 315 may be based on multiple uplink control channels (e.g., temporally overlapping uplink control channels) whose associated UCI have been multiplexed for transmission in the uplink control channel 315. In such examples, there may be a single control message 335 for both uplink control channels. Alternatively, there may be a respective control message 335 for each uplink control channel. In any event, each uplink control channel may have at least one associated priority level indicated by the network entity 105.

If the uplink control channels are associated with matching priority levels (e.g., each uplink control channel is associated with priority level P1), the UCI associated with the uplink control channels may be multiplexed to generate the UCI associated with uplink control channel 315. However, if the uplink control channels are associated with different priority levels, the UE 115 may separately perform cross-channel multiplexing for the uplink control channels. For instance, for the first uplink control channel, the UE 115 may select (for cross-channeling multiplexing) a first uplink data channel 310 based on the priority level associated with the first uplink control channel. Similarly, for the second uplink control channel, the UE 115 may select (for cross-channeling multiplexing) a second uplink data channel 310 based on the priority level associated with the second uplink control channel.

Thus, the UE 115 may use the priority level associated with an uplink control channel as a basis for selecting one or more uplink data channels for cross-channel multiplexing.

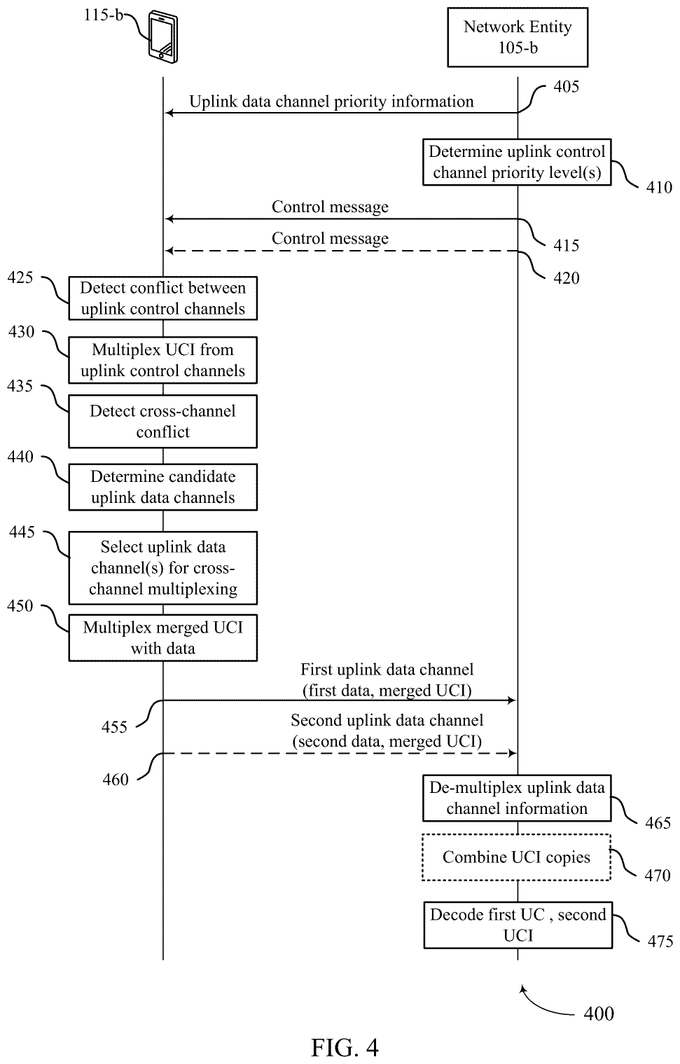

FIG. 4 shows an example of a process flow 400 that supports management of uplink multiplexing in a wireless communications system in accordance with one or more aspects of the present disclosure. The process flow 400 may be implemented by a UE 115-b and a network entity 105-b. Implementation of the process flow 400 may allow the UE 115-b to use an indicated priority level to select one or more uplink data channels for cross-channel multiplexing with one or more uplink control channels. The process flow 400 may illustrate an example in which multiple uplink control channels are multiplexed together before the UE 115-b performs cross-channel multiplexing with an uplink data channel.

At 405, the network entity 105-b may transmit priority information for one or more uplink data channels associated with the UE 115-b. The priority information may include one or more priority levels assigned to one or more of the uplink data channels. The priority information for different uplink data channels may be conveyed in a single message or in separate messages that are respective to the uplink data channels. A message that conveys the priority information for an uplink data channel may be a DCI message that schedules the uplink data channel, an RRC message that configures the uplink data channel, or a MAC control element (MAC-CE) message associated with the uplink data channel.

At 410, the network entity 105-b may determine (e.g., select) the priority level(s) for one or more uplink control channels. For example, the network entity 105-b may determine a first priority level for a first uplink control channel. If there is a second uplink control channel associated with the UE 115-b, the network entity 105-b may determine a second priority level for the second uplink control channel. The first priority level and the second priority level may be the same or different.

In some examples, the network entity 105-b may determine the priority level for an uplink control channel based on one or more metrics or parameters associated with the associated UCI, such as a type of the UCI (e.g., HARQ feedback versus CSI), a reliability factor associated with the UCI, an error rate threshold associated with the UCI, a latency tolerance associated with the UCI, and the like.

In some examples, the network entity 105-b may determine (e.g., select) multiple priority levels for an uplink control channel. In such examples, the network entity 105-b may determine the multiple priority levels based on the coding rate factor β, where the coding rate factor β represents the scaling factor between the coding rate of an uplink control channel and an uplink data channel (e.g., the coding rate of the uplink data channel may be equal to the coding rate of the uplink control channel multiplied by the coding rate factor β). For example, to reduce the coding rate factor β associated with transmission of the UCI of an uplink control channel, the network entity 105-b may determine multiple priority levels for the uplink control channel so that the UCI is transmitted in multiple uplink control channels.

At 415, the network entity 105-b may transmit a first control message that indicates one or more priority levels associated with the first uplink control channel. For example, the first control message may indicate a first priority level for the first uplink control channel and potentially one or more additional priority levels for the first uplink control channel. In some examples, the first control message may also indicate a second priority level (and potentially one or more additional priority levels) for the second uplink control channel. Alternatively, the second priority level (and potentially one or more additional priority levels) for the second uplink control channel may be indicated in a second control message transmitted by the network entity 105-b at 420. A control message that indicates the priority level for an uplink control channel may be a DCI message that schedules the uplink control channel, an RRC message that configures the uplink control channel, or a MAC-CE message associated with the uplink control channel.

At 425, the UE 115-b may detect a cross-channel conflict between the first uplink control channel and the second uplink control channel. For example, the UE 115-b may determine that the first uplink control channel overlaps in time with the second uplink control channel.

At 430, the UE 115-b may (e.g., if the uplink control channels have matching priority levels) multiplex the UCI associated with the uplink control channels. For example, the UE 115-b may multiplex first UCI associated with the first uplink control channel with second UCI associated with the second uplink channel. The UE 115-b may multiplex the first UCI with the second UCI based on the first uplink control channel and the second uplink control channel having matching priority levels (e.g., the first priority level being equal to the second priority level). The UE 115-b may determine a third uplink control channel associated with the multiplexed UCI, referred to as merged UCI, based on the sizes of the first UCI and the second UCI.

At 435, the UE 115-b may detect a cross-channel conflict between the third uplink control channel and one or more uplink data channels. For example, the UE 115-b may determine that the third uplink control channel overlaps in time with the one or more uplink data channel channels.

At 440, the UE 115-b may determine a set of candidate uplink data channels for cross-channel multiplexing based on detecting the cross-channel conflict. The UE 115-b may determine the set of candidate uplink data channels based on the duration and timing of the third uplink control channel.

At 445, the UE 115-b may select one or more uplink data channels (from the set of candidate uplink data channels) for cross-channel multiplexing. If the merged UCI is associated with a single priority level (e.g., priority level P1), the UE 115-b may select for cross-channel multiplexing the uplink data channel(s) associated with priority level P1. If the merged UCI is associated with multiple priority levels (e.g., priority level P1, priority level P2), a scenario which may occur when both the first UCI and the second UCI are associated with multiple matching priority levels, the UE 115-b may select for cross-channel multiplexing the uplink data channels associated with priority level P1 and priority level P2.

At 450, the UE 115-b may multiplex the merged UCI with the data associated with the selected uplink data channel(s). If a first uplink data channel is selected for cross-channel multiplexing, the UE 115-b may multiplex the merged UCI with first data associated with the first uplink data channel. If a second uplink data channel is selected for cross-channel multiplexing, the UE 115-b may multiplex a copy of the merged UCI with second data associated with the second uplink data channel.

At 455, the UE 115-b may transmit, in the first uplink data channel, the multiplexed first data and the merged UCI. The UE 115-b may refrain from transmitting in the third uplink control channel. At 460, the UE 115-b may transmit, in the second uplink data channel, the multiplexed second data and copy of the merged UCI.

At 465, the network entity 105-b may de-multiplex the information conveyed by the uplink data channel(s). For example, the network entity 105-b may de-multiplex the multiplexed first data and the merged UCI conveyed by the first uplink data channel. Additionally, the network entity 105-b may de-multiplex the multiplexed second data and the copy of the merged UCI conveyed by the second uplink data channel.

At 470, the network entity 105-b may combine the copies of the first UCI and may combine the copies of the second UCI. Accordingly, at 475, the network entity 105-b may use the combined copies of the first UCI to decode the first UCI and may use the combined copies of the second UCI to decode the second UCI.

Alternative examples of the foregoing may be implemented, where some operations are performed in a different order than described, are performed in parallel, are performed serially, or are not performed at all. In some cases, operations may include additional features not mentioned herein, or further operations may be added. Additionally, certain operations may be performed multiple times or certain combinations of operations may repeat or cycle.

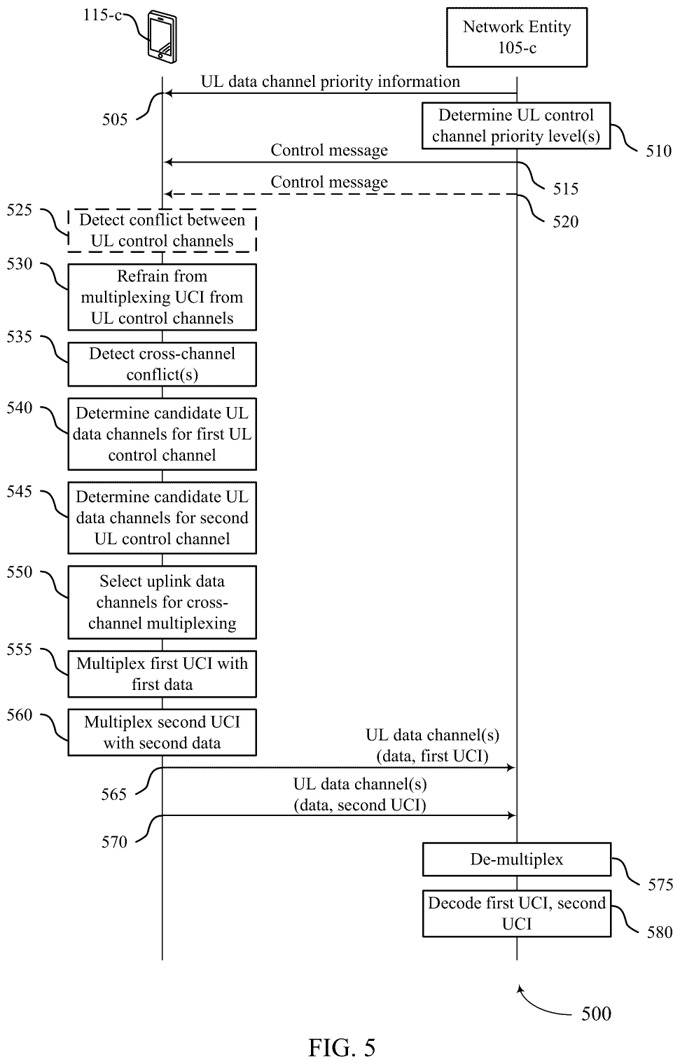

FIG. 5 shows an example of a process flow 500 that supports management of uplink multiplexing in a wireless communications system in accordance with one or more aspects of the present disclosure. The process flow 500 may be implemented by a UE 115-c and a network entity 105-c. Implementation of the process flow 500 may allow the UE 115-c to use an indicated priority level to select one or more destination uplink data channels for cross-channel multiplexing. The process flow 500 may illustrate an example in which multiple uplink control channels are separately multiplexed with respective uplink data channel(s).

At 505, the network entity 105-c may transmit priority information for one or more uplink data channels associated with the UE 115-c. The priority information may include one or more priority levels assigned to one or more of the uplink data channels. The priority information for different uplink data channels may be conveyed in a single message or in separate messages that are respective to the uplink data channels. A message that conveys the priority information for an uplink data channel may be a DCI message that schedules the uplink data channel, an RRC message that configures the uplink data channel, or a MAC-CE message associated with the uplink data channel.

At 510, the network entity 105-c may determine (e.g., select) the priority level(s) for one or more uplink control channels. For example, the network entity 105-c may determine a first priority level for a first uplink control channel. And the network entity 105-c may determine a second priority level for a second uplink control channel. The first priority level and the second priority may be different.

In some examples, the network entity 105-c may determine the priority level for an uplink control channel based on one or more metrics or parameters associated with the associated UCI, such as a type of the UCI (e.g., HARQ feedback versus CSI), a reliability factor associated with the UCI, an error rate threshold associated with the UCI, a latency tolerance associated with the UCI, and the like. In some examples, the network entity 105-c may determine (e.g., select) multiple priority levels for an uplink control channel. In such examples, the network entity 105-c may determine the multiple priority levels based on the coding rate factor β. For example, to reduce the coding rate factor β associated with transmission of the UCI of an uplink control channel, the network entity 105-c may determine multiple priority levels for the uplink control channel so that the UCI is transmitted in multiple uplink control channels.

At 515, the network entity 105-c may transmit a first control message that indicates one or more priority levels associated with the first uplink control channel. For example, the first control message may indicate a first priority level for the first uplink control channel and potentially one or more additional priority levels for the first uplink control channel. In some examples, the first control message may also indicate a second priority level (and potentially one or more additional priority levels) for the second uplink control channel. Alternatively, the second priority level (and potentially one or more additional priority levels) for the second uplink control channel may be indicated in a second control message transmitted by the network entity 105-c at 520. A control message that indicates the priority level for an uplink control channel may be a DCI message that schedules the uplink control channel, an RRC message that configures the uplink control channel, or a MAC-CE message associated with the uplink control channel.

At 525, the UE 115-c may detect a cross-channel conflict between the first uplink control channel and the second uplink control channel. For example, the UE 115-c may determine that the first uplink control channel overlaps in time with the second uplink control channel.

At 530, the UE 115-c may refrain from multiplexing the UCI associated with the uplink control channels. For example, the UE 115-c may refrain from multiplexing first UCI associated with the first uplink control channel with second UCI associated with the second uplink channel. The UE 115-c may refrain from multiplexing the first UCI with the second UCI based on the first uplink control channel and the second uplink control channel having different priority levels (e.g., the first priority level not being equal to the second priority level).

At 535, the UE 115-c may detect a cross-channel conflict between the first uplink control channel and one or more uplink data channels. For example, the UE 115-c may determine that the first uplink control channel overlaps in time with the one or more uplink data channel channels. The UE 115-c may also detect a cross-channel conflict between the second uplink control channel and one or more uplink data channels. For example, the UE 115-c may determine that the second uplink control channel overlaps in time with the one or more uplink data channel channels.

At 540, the UE 115-c may determine a first set of candidate uplink data channels for cross-channel multiplexing with the first uplink control channel. The UE 115-c may determine the first set of candidate uplink data channels based on the duration and timing of the first uplink control channel.

At 545, the UE 115-c may determine a second set of candidate uplink data channels for cross-channel multiplexing with the second uplink control channel. The UE 115-c may determine the second set of candidate uplink data channels based on the duration and timing of the second uplink control channel. The second set of candidate uplink data channels may include none of, some of, or all of the uplink data channels included in the first set of candidate uplink data channels.

At 550, the UE 115-c may select one or more uplink data channels, from the first set of candidate uplink data channels, for cross-channel multiplexing with the first uplink control channel. If the first uplink control channel is associated with a single priority level (e.g., priority level P1), the UE 115-c may select for cross-channel multiplexing the uplink data channel(s) associated with priority level P1. If the first uplink control channel is associated with multiple priority levels (e.g., priority level P1, priority level P2), the UE 115-c may select for cross-channel multiplexing the uplink data channels associated with priority level P1 and priority level P2.

Also at 550, the UE 115-c may select one or more uplink data channels, from the second set of candidate uplink data channels, for cross-channel multiplexing with the second uplink control channel. If the second uplink control channel is associated with a single priority level (e.g., priority level P3), the UE 115-c may select for cross-channel multiplexing the uplink data channel(s) associated with priority level P3. If the second uplink control channel is associated with multiple priority levels (e.g., priority level P3, priority level P4), the UE 115-c may select for cross-channel multiplexing the uplink data channels associated with priority level P3 and priority level P4.

At 555, the UE 115-c may multiplex the first UCI with data associated with the selected uplink data channel(s) from the first set of candidate uplink data channels. For example, the UE 115-c may multiplex the first UCI with first data from a first uplink data channel and may multiplex a copy of the first UCI with second data from a second uplink data channel. At 560, the UE 115-c may multiplex the second UCI with data associated with the selected uplink data channel(s) from the second set of candidate uplink data channels. For example, the UE 115-c may multiplex the second UCI with third data from a third uplink data channel and may multiplex a copy of the second UCI with fourth data from a fourth uplink data channel.

At 565, the UE 115-c may transmit, in the selected uplink data channel(s) from the first set of candidate uplink data channels, the first UCI multiplexed with data. For example, the UE 115-c may transmit, in the first uplink data channel, the first UCI multiplexed with the first data and may transmit, in the second uplink data channel, the copy of the first UCI multiplexed with the second data. The UE 115-c may refrain from transmitting the first UCI in the first uplink control channel.

At 570, the UE 115-c may transmit, in the selected uplink data channel(s) from the second set of candidate uplink data channels, the second UCI multiplexed with data. For example, the UE 115-c may transmit, in the third uplink data channel, the second UCI multiplexed with the third data and may transmit, in the fourth uplink data channel, the copy of the second UCI multiplexed with the fourth data. The UE 115-c may refrain from transmitting the second UCI in the second uplink control channel.

At 575, the network entity 105-c may de-multiplex the information conveyed by the uplink data channel(s). For example, the network entity 105-c may de-multiplex the multiplexed first data and the first UCI conveyed by the first uplink data channel and may de-multiplex the multiplexed second data and the first UCI conveyed by the second uplink data channel. Similarly, the network entity 105-c may de-multiplex the multiplexed third data and the second UCI conveyed by the third uplink data channel and may de-multiplex the multiplexed fourth data and the second UCI conveyed by the fourth uplink data channel.

The network entity 105-c may combine the copies of the first UCI and may combine the copies of the second UCI. Accordingly, at 580, the network entity 105-c may use the combined copies of the first UCI to decode the first UCI and may use the combined copies of the second UCI to decode the second UCI.

Alternative examples of the foregoing may be implemented, where some operations are performed in a different order than described, are performed in parallel, are performed serially, or are not performed at all. In some cases, operations may include additional features not mentioned herein, or further operations may be added. Additionally, certain operations may be performed multiple times or certain combinations of operations may repeat or cycle.

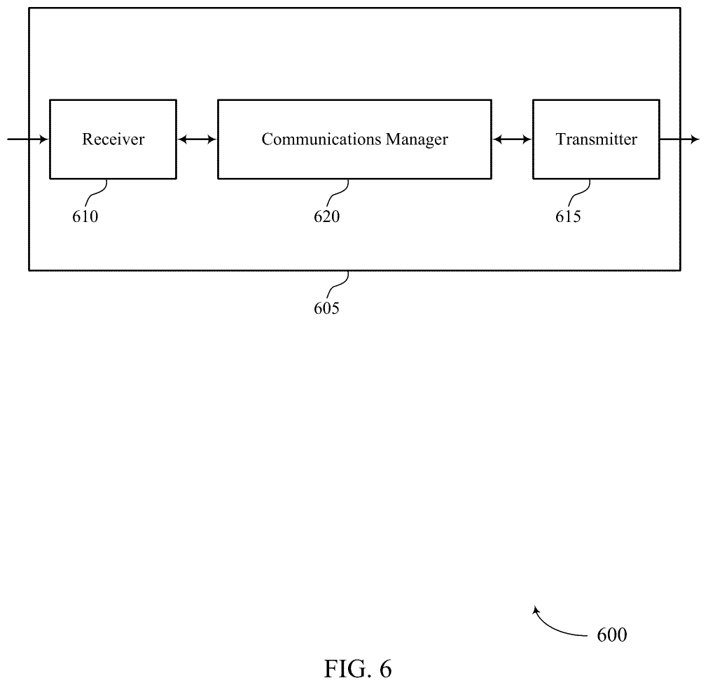

FIG. 6 shows a block diagram 600 of a device 605 that supports management of uplink multiplexing in a wireless communications system in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to management of uplink multiplexing in a wireless communications system). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to management of uplink multiplexing in a wireless communications system). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of management of uplink multiplexing in a wireless communications system as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a control message that is associated with an uplink control channel and that indicates a priority level associated with an uplink data channel. The communications manager 620 is capable of, configured to, or operable to support a means for multiplexing uplink control information associated with the uplink control channel with data associated with the uplink data channel based on the priority level being associated with the uplink data channel. The communications manager 620 is capable of, configured to, or operable to support a means for transmitting the uplink control information multiplexed with the data in the uplink data channel.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing.

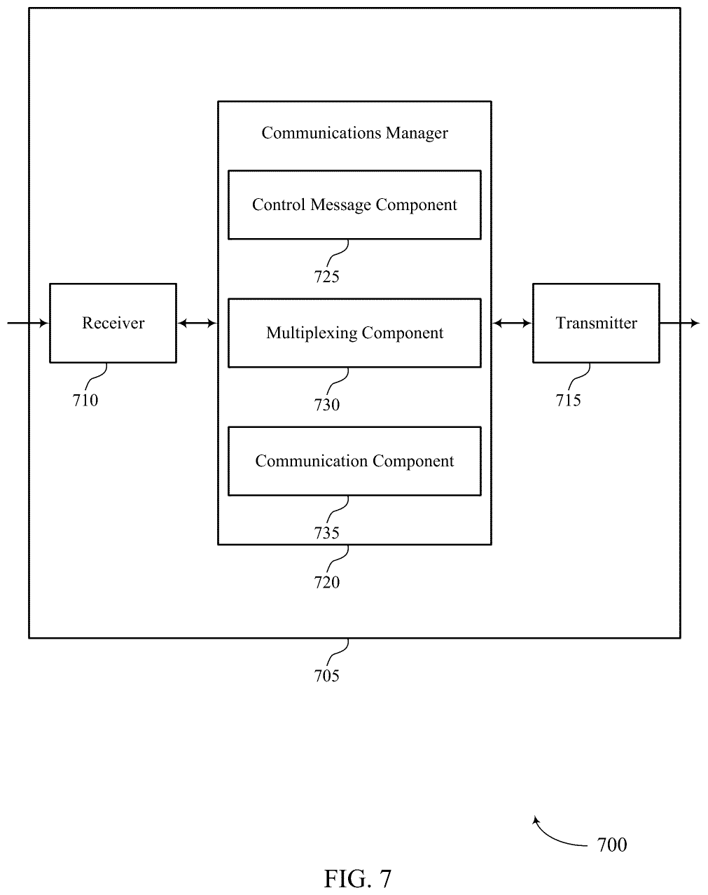

FIG. 7 shows a block diagram 700 of a device 705 that supports management of uplink multiplexing in a wireless communications system in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to management of uplink multiplexing in a wireless communications system). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to management of uplink multiplexing in a wireless communications system). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of management of uplink multiplexing in a wireless communications system as described herein. For example, the communications manager 720 may include a control message component 725, a multiplexing component 730, a communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control message component 725 is capable of, configured to, or operable to support a means for receiving a control message that is associated with an uplink control channel and that indicates a priority level associated with an uplink data channel. The multiplexing component 730 is capable of, configured to, or operable to support a means for multiplexing uplink control information associated with the uplink control channel with data associated with the uplink data channel based on the priority level being associated with the uplink data channel. The communication component 735 is capable of, configured to, or operable to support a means for transmitting the uplink control information multiplexed with the data in the uplink data channel.

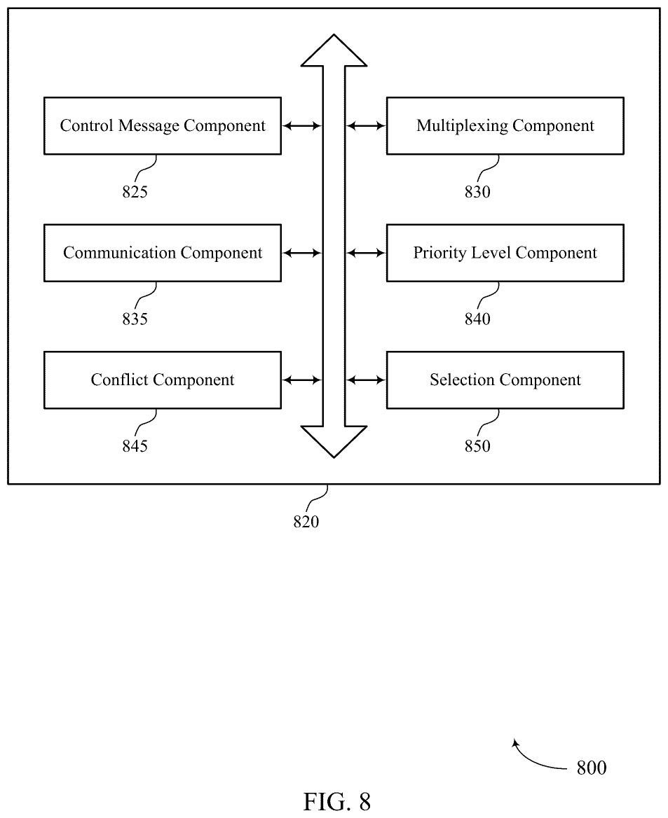

FIG. 8 shows a block diagram 800 of a communications manager 820 that supports management of uplink multiplexing in a wireless communications system in accordance with one or more aspects of the present disclosure. The communications manager 820 may be an example of aspects of a communications manager 620, a communications manager 720, or both, as described herein. The communications manager 820, or various components thereof, may be an example of means for performing various aspects of management of uplink multiplexing in a wireless communications system as described herein. For example, the communications manager 820 may include a control message component 825, a multiplexing component 830, a communication component 835, a priority level component 840, a conflict component 845, a selection component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The control message component 825 is capable of, configured to, or operable to support a means for receiving a control message that is associated with an uplink control channel and that indicates a priority level associated with an uplink data channel. The multiplexing component 830 is capable of, configured to, or operable to support a means for multiplexing uplink control information associated with the uplink control channel with data associated with the uplink data channel based on the priority level being associated with the uplink data channel. The communication component 835 is capable of, configured to, or operable to support a means for transmitting the uplink control information multiplexed with the data in the uplink data channel.

In some examples, the priority level component 840 is capable of, configured to, or operable to support a means for receiving an indication of a priority level assigned to the uplink data channel, where the uplink control information is multiplexed with the data associated with the uplink data channel based on the priority level indicated by the control message matching the priority level assigned to the uplink data channel.

In some examples, the multiplexing component 830 is capable of, configured to, or operable to support a means for multiplexing a copy of the uplink control information with second data associated with a second uplink data channel based on the second uplink data channel being associated with the priority level. In some examples, the communication component 835 is capable of, configured to, or operable to support a means for transmitting the copy of the uplink control information multiplexed with the second data in the second uplink data channel.

In some examples, the control message indicates a second priority level associated with a second uplink data channel, and the multiplexing component 830 is capable of, configured to, or operable to support a means for multiplexing a copy of the uplink control information with second data associated with the second uplink data channel based on the second priority level being associated with the second uplink data channel. In some examples, the control message indicates a second priority level associated with a second uplink data channel, and the communication component 835 is capable of, configured to, or operable to support a means for transmitting the copy of the uplink control information multiplexed with the second data in the second uplink data channel.

In some examples, the control message component 825 is capable of, configured to, or operable to support a means for receiving a second control message that is associated with a second uplink control channel and that indicates the priority level. In some examples, the multiplexing component 830 is capable of, configured to, or operable to support a means for multiplexing, based on the control message and the second control message indicating the same priority level, the uplink control information associated with the uplink control channel with second uplink control information associated with the second uplink control channel, where multiplexing the uplink control information with the data includes multiplexing the second uplink control information with the data.

In some examples, the priority level is a priority level assigned to the uplink data channel. In some examples, the uplink control information is multiplexed with the data associated with the uplink data channel based on the priority level being the priority level assigned to the uplink data channel.

In some examples, the priority level includes a priority level assigned to the uplink control channel. In some examples, the uplink control information is multiplexed with the data associated with the uplink data channel based on the priority level assigned to the uplink control channel matching a priority level assigned to the uplink data channel.

In some examples, the conflict component 845 is capable of, configured to, or operable to support a means for determining a set of uplink data channels that overlap in time with the uplink control channel. In some examples, the selection component 850 is capable of, configured to, or operable to support a means for selecting the uplink data channel for multiplexing the uplink control information based on the uplink data channel being included in the set of uplink data channels.

In some examples, the control message includes an RRC message that configures the uplink control channel or includes a downlink uplink control information (DCI) message that schedules the uplink control channel.

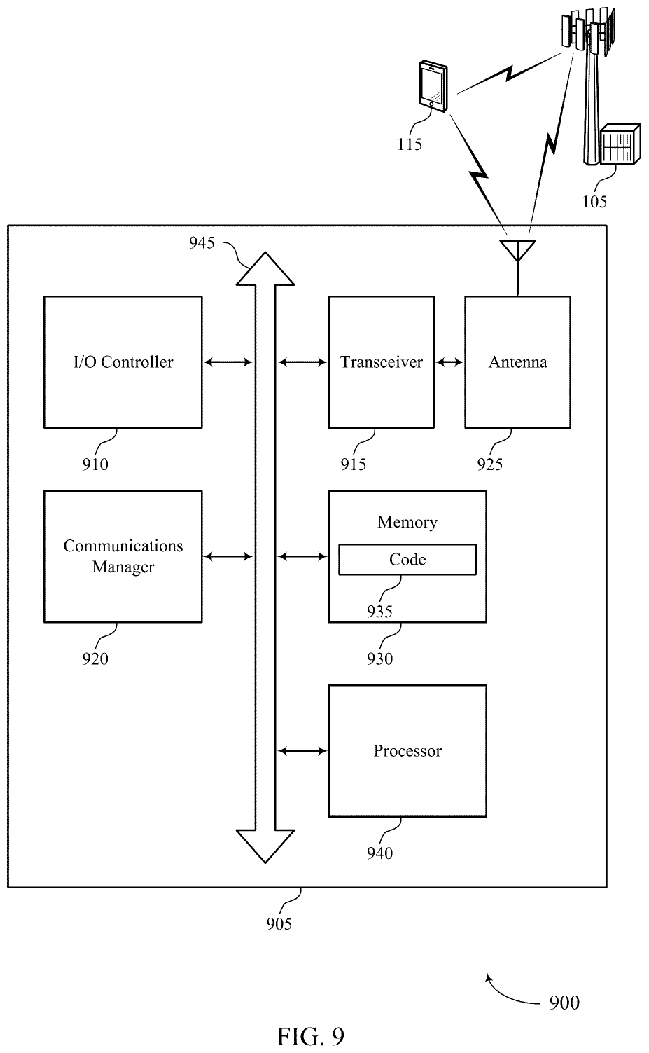

FIG. 9 shows a diagram of a system 900 including a device 905 that supports management of uplink multiplexing in a wireless communications system in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting management of uplink multiplexing in a wireless communications system). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a control message that is associated with an uplink control channel and that indicates a priority level associated with an uplink data channel. The communications manager 920 is capable of, configured to, or operable to support a means for multiplexing uplink control information associated with the uplink control channel with data associated with the uplink data channel based on the priority level being associated with the uplink data channel. The communications manager 920 is capable of, configured to, or operable to support a means for transmitting the uplink control information multiplexed with the data in the uplink data channel.

By including or configuring the communications manager 920 in accordance with examples as described herein, the device 905 may support techniques for, more efficient utilization of communication resources, improved coordination between devices, improved user experience related to reduced processing.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of management of uplink multiplexing in a wireless communications system as described herein, or the at least one processor 940 and the at least one memory 930 may be otherwise configured to, individually or collectively, perform or support such operations.

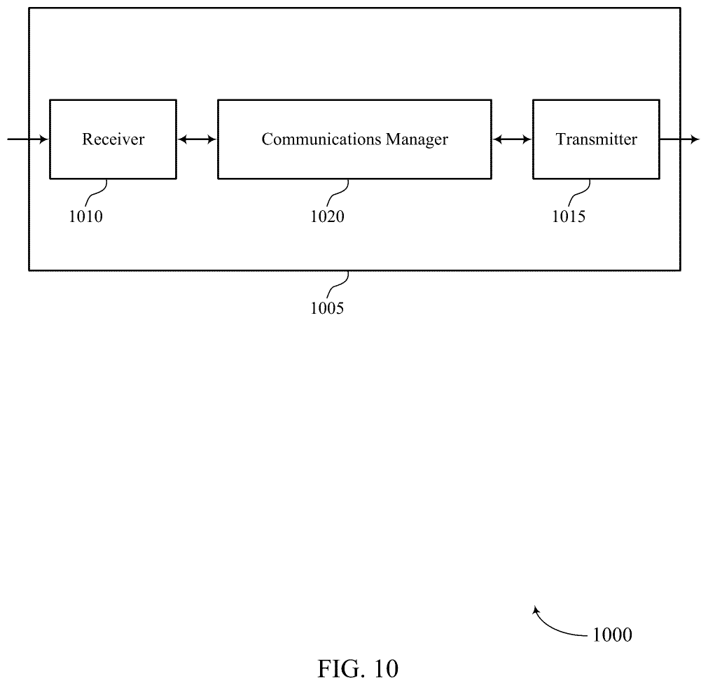

FIG. 10 shows a block diagram 1000 of a device 1005 that supports management of uplink multiplexing in a wireless communications system in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of management of uplink multiplexing in a wireless communications system as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting a control message that is associated with an uplink control channel and that indicates a priority level associated with an uplink data channel. The communications manager 1020 is capable of, configured to, or operable to support a means for obtaining, in the uplink data channel based on the priority level being associated with the uplink data channel, uplink control information that is associated with the uplink control channel and that is multiplexed with data associated with the uplink data channel. The communications manager 1020 is capable of, configured to, or operable to support a means for decoding the uplink control information based on receiving the uplink control information multiplexed with the data.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing.

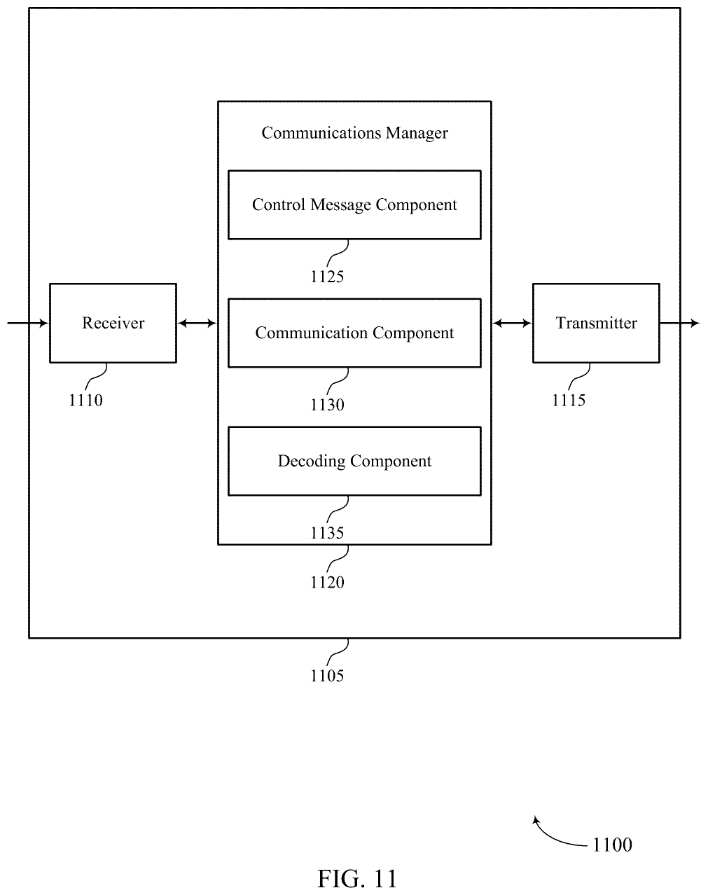

FIG. 11 shows a block diagram 1100 of a device 1105 that supports management of uplink multiplexing in a wireless communications system in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of management of uplink multiplexing in a wireless communications system as described herein. For example, the communications manager 1120 may include a control message component 1125, a communication component 1130, a decoding component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The control message component 1125 is capable of, configured to, or operable to support a means for outputting a control message that is associated with an uplink control channel and that indicates a priority level associated with an uplink data channel. The communication component 1130 is capable of, configured to, or operable to support a means for obtaining, in the uplink data channel based on the priority level being associated with the uplink data channel, uplink control information that is associated with the uplink control channel and that is multiplexed with data associated with the uplink data channel. The decoding component 1135 is capable of, configured to, or operable to support a means for decoding the uplink control information based on receiving the uplink control information multiplexed with the data.

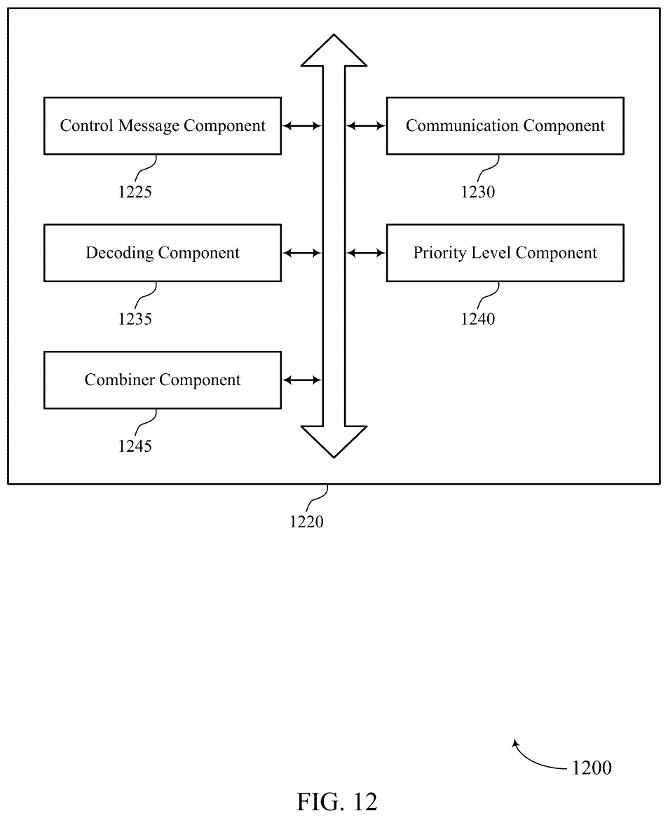

FIG. 12 shows a block diagram 1200 of a communications manager 1220 that supports management of uplink multiplexing in a wireless communications system in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of management of uplink multiplexing in a wireless communications system as described herein. For example, the communications manager 1220 may include a control message component 1225, a communication component 1230, a decoding component 1235, a combiner component 1245, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The control message component 1225 is capable of, configured to, or operable to support a means for outputting a control message that is associated with an uplink control channel and that indicates a priority level associated with an uplink data channel. The communication component 1230 is capable of, configured to, or operable to support a means for obtaining, in the uplink data channel based on the priority level being associated with the uplink data channel, uplink control information that is associated with the uplink control channel and that is multiplexed with data associated with the uplink data channel. The decoding component 1235 is capable of, configured to, or operable to support a means for decoding the uplink control information based on receiving the uplink control information multiplexed with the data.

In some examples, the priority level component 1240 is capable of, configured to, or operable to support a means for outputting an indication of a priority level assigned to the uplink data channel, where the uplink control information is received in the uplink data channel based on the priority level indicated by the control message matching the priority level assigned to the uplink data channel.

In some examples, the communication component 1230 is capable of, configured to, or operable to support a means for obtaining, in a second uplink data channel based on the second uplink data channel being associated with the priority level, a copy of the uplink control information multiplexed with second data.

In some examples, the control message indicates a second priority level, and the communication component 1230 is capable of, configured to, or operable to support a means for obtaining, in a second uplink data channel based on the second priority level being associated with the second uplink data channel, a copy of the uplink control information that is multiplexed with second uplink data associated with the second uplink data channel.

In some examples, the combiner component 1245 is capable of, configured to, or operable to support a means for combining the uplink control information with the copy of the uplink control information, where decoding the uplink control information includes decoding the combination of the uplink control information and the copy of the uplink control information.

In some examples, the control message component 1225 is capable of, configured to, or operable to support a means for outputting a second control message that is associated with a second uplink control channel and that indicates the priority level. In some examples, the communication component 1230 is capable of, configured to, or operable to support a means for obtaining, based on the control message and the second control message indicating the same priority level, the uplink control information multiplexed with second uplink control information that is associated with the second uplink control channel.

In some examples, the priority level is a priority level assigned to the uplink data channel. In some examples, the uplink control information is received in the uplink data channel based on the priority level being the priority level assigned to the uplink data channel.

In some examples, the priority level includes a priority level assigned to the uplink control channel. In some examples, the uplink control information is received in the uplink data channel based on the priority level assigned to the uplink control channel matching a priority level assigned to the uplink data channel.

In some examples, the control message includes an RRC message that configures the uplink control channel or includes a downlink uplink control information (DCI) message that schedules the uplink control channel.

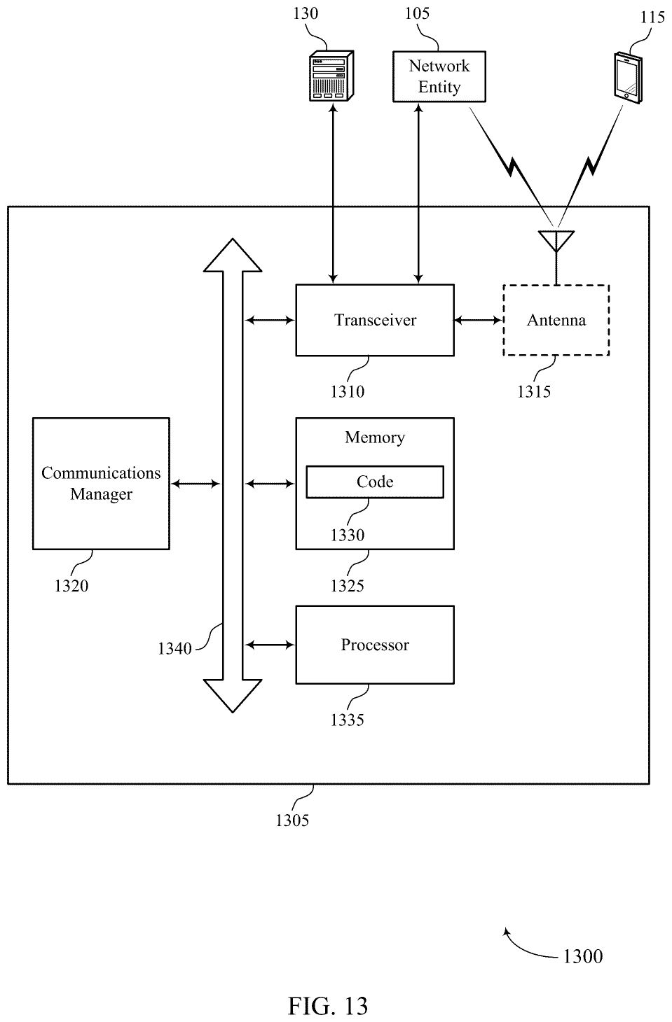

FIG. 13 shows a diagram of a system 1300 including a device 1305 that supports management of uplink multiplexing in a wireless communications system in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting management of uplink multiplexing in a wireless communications system). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting a control message that is associated with an uplink control channel and that indicates a priority level associated with an uplink data channel. The communications manager 1320 is capable of, configured to, or operable to support a means for obtaining, in the uplink data channel based on the priority level being associated with the uplink data channel, uplink control information that is associated with the uplink control channel and that is multiplexed with data associated with the uplink data channel. The communications manager 1320 is capable of, configured to, or operable to support a means for decoding the uplink control information based on receiving the uplink control information multiplexed with the data.

By including or configuring the communications manager 1320 in accordance with examples as described herein, the device 1305 may support techniques for more efficient utilization of communication resources, improved coordination between devices, and improved user experience related to reduced processing.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of management of uplink multiplexing in a wireless communications system as described herein, or the at least one processor 1335 and the at least one memory 1325 may be otherwise configured to, individually or collectively, perform or support such operations.

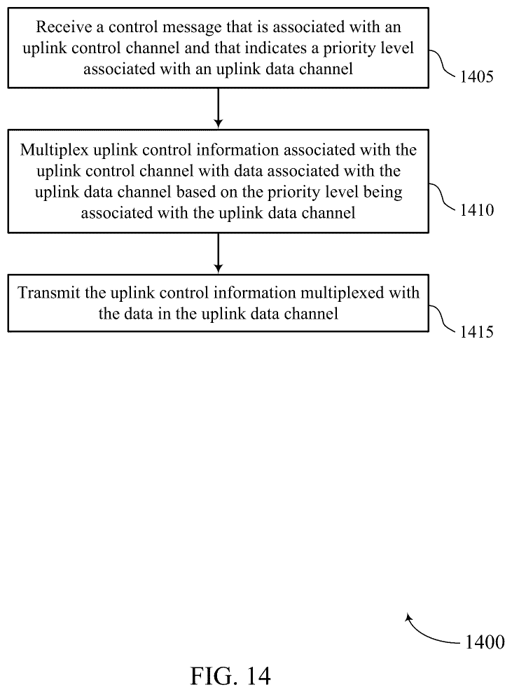

FIG. 14 shows a flowchart illustrating a method 1400 that supports management of uplink multiplexing in a wireless communications system in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message that is associated with an uplink control channel and that indicates a priority level associated with an uplink data channel. The operations of block 1405 may be performed in accordance with examples as disclosed herein. In some examples, aspects of the operations of 1405 may be performed by a control message component 825 as described with reference to FIG. 8.

At 1410, the method may include multiplexing uplink control information associated with the uplink control channel with data associated with the uplink data channel based on the priority level being associated with the uplink data channel. The operations of block 1410 may be performed in accordance with examples as disclosed herein. In some examples, aspects of the operations of 1410 may be performed by a multiplexing component 830 as described with reference to FIG. 8.

At 1415, the method may include transmitting the uplink control information multiplexed with the data in the uplink data channel. The operations of block 1415 may be performed in accordance with examples as disclosed herein. In some examples, aspects of the operations of 1415 may be performed by a communication component 835 as described with reference to FIG. 8.

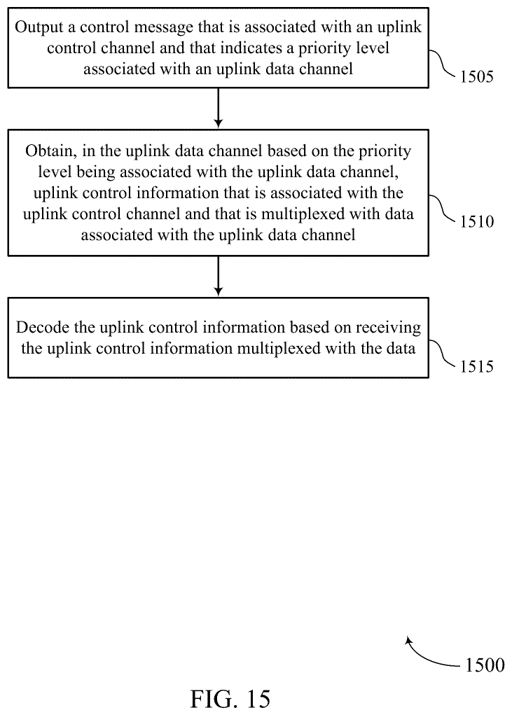

FIG. 15 shows a flowchart illustrating a method 1500 that supports management of uplink multiplexing in a wireless communications system in accordance with aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting a control message that is associated with an uplink control channel and that indicates a priority level associated with an uplink data channel. The operations of block 1505 may be performed in accordance with examples as disclosed herein. In some examples, aspects of the operations of 1505 may be performed by a control message component 1225 as described with reference to FIG. 12.

At 1510, the method may include obtaining, in the uplink data channel based on the priority level being associated with the uplink data channel, uplink control information that is associated with the uplink control channel and that is multiplexed with data associated with the uplink data channel. The operations of block 1510 may be performed in accordance with examples as disclosed herein. In some examples, aspects of the operations of 1510 may be performed by a communication component 1230 as described with reference to FIG. 12.

At 1515, the method may include decoding the uplink control information based on receiving the uplink control information multiplexed with the data. The operations of block 1515 may be performed in accordance with examples as disclosed herein. In some examples, aspects of the operations of 1515 may be performed by a decoding component 1235 as described with reference to FIG. 12.

The following provides an overview of aspects of the present disclosure:
Aspect 1: A method for wireless communications at a UE, comprising: receiving a control message that is associated with an uplink control channel and that indicates a priority level associated with an uplink data channel; multiplexing uplink control information associated with the uplink control channel with data associated with the uplink data channel based at least in part on the priority level being associated with the uplink data channel; and transmitting the uplink control information multiplexed with the data in the uplink data channel.
Aspect 2: The method of aspect 1, further comprising: receiving an indication of a priority level assigned to the uplink data channel, wherein the uplink control information is multiplexed with the data associated with the uplink data channel based at least in part on the priority level indicated by the control message matching the priority level assigned to the uplink data channel.
Aspect 3: The method of any of aspects 1 through 2, further comprising: multiplexing a copy of the uplink control information with second data associated with a second uplink data channel based at least in part on the second uplink data channel being associated with the priority level; and transmitting the copy of the uplink control information multiplexed with the second data in the second uplink data channel.
Aspect 4: The method of any of aspects 1 through 3, wherein the control message indicates a second priority level associated with a second uplink data channel, the method further comprising: multiplexing a copy of the uplink control information with second data associated with the second uplink data channel based at least in part on the second priority level being associated with the second uplink data channel; and transmitting the copy of the uplink control information multiplexed with the second data in the second uplink data channel.
Aspect 5: The method of any of aspects 1 through 4, further comprising: receiving a second control message that is associated with a second uplink control channel and that indicates the priority level; and multiplexing, based at least in part on the control message and the second control message indicating the same priority level, the uplink control information associated with the uplink control channel with second uplink control information associated with the second uplink control channel, wherein multiplexing the uplink control information with the data comprises multiplexing the second uplink control information with the data.
Aspect 6: The method of any of aspects 1 through 5, wherein the priority level is a priority level assigned to the uplink data channel, and the uplink control information is multiplexed with the data associated with the uplink data channel based at least in part on the priority level being the priority level assigned to the uplink data channel.
Aspect 7: The method of any of aspects 1 through 5, wherein the priority level comprises a priority level assigned to the uplink control channel, and the uplink control information is multiplexed with the data associated with the uplink data channel based at least in part on the priority level assigned to the uplink control channel matching a priority level assigned to the uplink data channel.
Aspect 8: The method of any of aspects 1 through 7, further comprising: determining a set of uplink data channels that overlap in time with the uplink control channel; and selecting the uplink data channel for multiplexing the uplink control information based at least in part on the uplink data channel being included in the set of uplink data channels.
Aspect 9: The method of any of aspects 1 through 8, wherein the control message comprises an RRC message that configures the uplink control channel or comprises a downlink uplink control information (DCI) message that schedules the uplink control channel.
Aspect 10: A method for wireless communications at a network entity, comprising: outputting a control message that is associated with an uplink control channel and that indicates a priority level associated with an uplink data channel; obtaining, in the uplink data channel based at least in part on the priority level being associated with the uplink data channel, uplink control information that is associated with the uplink control channel and that is multiplexed with data associated with the uplink data channel; and decoding the uplink control information based at least in part on receiving the uplink control information multiplexed with the data.
Aspect 11: The method of aspect 10, further comprising: outputting an indication of a priority level assigned to the uplink data channel, wherein the uplink control information is received in the uplink data channel based at least in part on the priority level indicated by the control message matching the priority level assigned to the uplink data channel.
Aspect 12: The method of any of aspects 10 through 11, further comprising: obtaining, in a second uplink data channel based at least in part on the second uplink data channel being associated with the priority level, a copy of the uplink control information multiplexed with second data.
Aspect 13: The method of any of aspects 10 through 12, wherein the control message indicates a second priority level, the method further comprising: obtaining, in a second uplink data channel based at least in part on the second priority level being associated with the second uplink data channel, a copy of the uplink control information that is multiplexed with second uplink data associated with the second uplink data channel.
Aspect 14: The method of aspect 13, further comprising: combining the uplink control information with the copy of the uplink control information, wherein decoding the uplink control information comprises decoding the combination of the uplink control information and the copy of the uplink control information.
Aspect 15: The method of any of aspects 10 through 14, further comprising: outputting a second control message that is associated with a second uplink control channel and that indicates the priority level; and obtaining, based at least in part on the control message and the second control message indicating the same priority level, the uplink control information multiplexed with second uplink control information that is associated with the second uplink control channel.
Aspect 16: The method of any of aspects 10 through 15, wherein the priority level is a priority level assigned to the uplink data channel, and the uplink control information is received in the uplink data channel based at least in part on the priority level being the priority level assigned to the uplink data channel.
Aspect 17: The method of any of aspects 10 through 15, wherein the priority level comprises a priority level assigned to the uplink control channel, and the uplink control information is received in the uplink data channel based at least in part on the priority level assigned to the uplink control channel matching a priority level assigned to the uplink data channel.
Aspect 18: The method of any of aspects 10 through 17, wherein the control message comprises an RRC message that configures the uplink control channel or comprises a downlink uplink control information (DCI) message that schedules the uplink control channel.
Aspect 19: An apparatus for wireless communications, comprising at least one processor and at least one memory coupled with the at least one processor, with instructions stored in the at least one memory, the instructions being executable by the at least one processor, individually or in any combination, to cause the apparatus to execute the code to cause the apparatus to perform a method of any of aspects 1 through 9.
Aspect 20: A UE for wireless communications, comprising at least one means for performing a method of any of aspects 1 through 9.
Aspect 21: A non-transitory computer-readable medium storing code for wireless communications, the code comprising instructions executable by one or more processors to perform a method of any of aspects 1 through 9.
Aspect 22: An apparatus for wireless communications, comprising at least one processor and at least one memory coupled with the at least one processor, with instructions stored in the at least one memory, the instructions being executable by the at least one processor, individually or in any combination, to cause the apparatus to to perform a method of any of aspects 10 through 18.
Aspect 23: A network entity for wireless communications, comprising at least one means for performing a method of any of aspects 10 through 18.
Aspect 24: A non-transitory computer-readable medium storing code for wireless communications, the code comprising instructions executable by one or more processors to perform a method of any of aspects 10 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
at least one processor; and
at least one memory coupled with the at least one processor, with instructions stored in the at least one memory, the instructions being executable by the at least one processor, individually or in any combination, to cause the apparatus to:
receive a control message that is associated with an uplink control channel and that indicates a priority level associated with an uplink data channel;
multiplex uplink control information associated with the uplink control channel with data associated with the uplink data channel based at least in part on the priority level being associated with the uplink data channel; and
transmit the uplink control information multiplexed with the data in the uplink data channel.

2. The apparatus of claim 1, wherein the instructions are further executable to cause the apparatus to:
receive an indication of a priority level assigned to the uplink data channel, wherein the uplink control information is multiplexed with the data associated with the uplink data channel based at least in part on the priority level indicated by the control message matching the priority level assigned to the uplink data channel.

3. The apparatus of claim 1, wherein the instructions are further executable to cause the apparatus to:
multiplex a copy of the uplink control information with second data associated with a second uplink data channel based at least in part on the second uplink data channel being associated with the priority level; and
transmit the copy of the uplink control information multiplexed with the second data in the second uplink data channel.

4. The apparatus of claim 1, wherein the control message indicates a second priority level associated with a second uplink data channel, and wherein the instructions are further executable to cause the apparatus to:
multiplexing a copy of the uplink control information with second data associated with the second uplink data channel based at least in part on the second priority level being associated with the second uplink data channel; and
transmitting the copy of the uplink control information multiplexed with the second data in the second uplink data channel.

5. The apparatus of claim 1, wherein the instructions are further executable to cause the apparatus to:
receiving a second control message that is associated with a second uplink control channel and that indicates the priority level; and
multiplexing, based at least in part on the control message and the second control message indicating the same priority level, the uplink control information associated with the uplink control channel with second uplink control information associated with the second uplink control channel, wherein multiplexing the uplink control information with the data comprises multiplexing the second uplink control information with the data.

6. The apparatus of claim 1, wherein the priority level is a priority level assigned to the uplink data channel, and wherein the uplink control information is multiplexed with the data associated with the uplink data channel based at least in part on the priority level being the priority level assigned to the uplink data channel.

7. The apparatus of claim 1, wherein the priority level comprises a priority level assigned to the uplink control channel, and wherein the uplink control information is multiplexed with the data associated with the uplink data channel based at least in part on the priority level assigned to the uplink control channel matching a priority level assigned to the uplink data channel.

8. The apparatus of claim 1, wherein the instructions are further executable to cause the apparatus to:
determine a set of uplink data channels that overlap in time with the uplink control channel; and
select the uplink data channel for multiplexing the uplink control information based at least in part on the uplink data channel being included in the set of uplink data channels.

9. The apparatus of claim 1, wherein the control message comprises a radio resource control (RRC) message that configures the uplink control channel or comprises a downlink uplink control information (DCI) message that schedules the uplink control channel.

10. An apparatus for wireless communications, comprising:
at least one processor; and
at least one memory coupled with the at least one processor, with instructions stored in the at least one memory, the instructions being executable by the at least one processor, individually or in any combination, to cause the apparatus to:
output a control message that is associated with an uplink control channel and that indicates a priority level associated with an uplink data channel;
obtain, in the uplink data channel based at least in part on the priority level being associated with the uplink data channel, uplink control information that is associated with the uplink control channel and that is multiplexed with data associated with the uplink data channel; and
decode the uplink control information based at least in part on receiving the uplink control information multiplexed with the data.

11. The apparatus of claim 10, wherein the instructions are further executable to cause the apparatus to:
output an indication of a priority level assigned to the uplink data channel, wherein the uplink control information is received in the uplink data channel based at least in part on the priority level indicated by the control message matching the priority level assigned to the uplink data channel.

12. The apparatus of claim 10, wherein the instructions are further executable to cause the apparatus to:
obtain, in a second uplink data channel based at least in part on the second uplink data channel being associated with the priority level, a copy of the uplink control information multiplexed with second data.

13. The apparatus of claim 10, wherein the control message indicates a second priority level, and wherein the instructions are further executable to cause the apparatus to:
obtain, in a second uplink data channel based at least in part on the second priority level being associated with the second uplink data channel, a copy of the uplink control information that is multiplexed with second uplink data associated with the second uplink data channel.

14. The apparatus of claim 13, wherein the instructions are further executable to cause the apparatus to:
combine the uplink control information with the copy of the uplink control information, wherein decoding the uplink control information comprises decoding the combination of the uplink control information and the copy of the uplink control information.

15. The apparatus of claim 10, wherein the instructions are further executable to cause the apparatus to:
output a second control message that is associated with a second uplink control channel and that indicates the priority level; and
obtain, based at least in part on the control message and the second control message indicating the same priority level, the uplink control information multiplexed with second uplink control information that is associated with the second uplink control channel.

16. The apparatus of claim 10, wherein the priority level is a priority level assigned to the uplink data channel, and wherein the uplink control information is received in the uplink data channel based at least in part on the priority level being the priority level assigned to the uplink data channel.

17. The apparatus of claim 10, wherein the priority level comprises a priority level assigned to the uplink control channel, and wherein the uplink control information is received in the uplink data channel based at least in part on the priority level assigned to the uplink control channel matching a priority level assigned to the uplink data channel.

18. The apparatus of claim 10, wherein the control message comprises a radio resource control (RRC) message that configures the uplink control channel or comprises a downlink uplink control information (DCI) message that schedules the uplink control channel.

19. A method for wireless communications at a user equipment (UE), comprising:
receiving a control message that is associated with an uplink control channel and that indicates a priority level associated with an uplink data channel;
multiplexing uplink control information associated with the uplink control channel with data associated with the uplink data channel based at least in part on the priority level being associated with the uplink data channel; and
transmitting the uplink control information multiplexed with the data in the uplink data channel.

20. The method of claim 19, further comprising:
receiving an indication of a priority level assigned to the uplink data channel, wherein the uplink control information is multiplexed with the data associated with the uplink data channel based at least in part on the priority level indicated by the control message matching the priority level assigned to the uplink data channel.

21. The method of claim 19, further comprising:
multiplexing a copy of the uplink control information with second data associated with a second uplink data channel based at least in part on the second uplink data channel being associated with the priority level; and
transmitting the copy of the uplink control information multiplexed with the second data in the second uplink data channel.

22. The method of claim 19, wherein the control message indicates a second priority level associated with a second uplink data channel, the method further comprising:
multiplexing a copy of the uplink control information with second data associated with the second uplink data channel based at least in part on the second priority level being associated with the second uplink data channel; and
transmitting the copy of the uplink control information multiplexed with the second data in the second uplink data channel.

23. The method of claim 19, further comprising:
receiving a second control message that is associated with a second uplink control channel and that indicates the priority level; and
multiplexing, based at least in part on the control message and the second control message indicating the same priority level, the uplink control information associated with the uplink control channel with second uplink control information associated with the second uplink control channel, wherein multiplexing the uplink control information with the data comprises multiplexing the second uplink control information with the data.

24. The method of claim 19, wherein the priority level is a priority level assigned to the uplink data channel, and wherein the uplink control information is multiplexed with the data associated with the uplink data channel based at least in part on the priority level being the priority level assigned to the uplink data channel.

25. A method for wireless communications at a network entity, comprising:
outputting a control message that is associated with an uplink control channel and that indicates a priority level associated with an uplink data channel;
obtaining, in the uplink data channel based at least in part on the priority level being associated with the uplink data channel, uplink control information that is associated with the uplink control channel and that is multiplexed with data associated with the uplink data channel; and
decoding the uplink control information based at least in part on receiving the uplink control information multiplexed with the data.

26. The method of claim 25, further comprising:
outputting an indication of a priority level assigned to the uplink data channel, wherein the uplink control information is received in the uplink data channel based at least in part on the priority level indicated by the control message matching the priority level assigned to the uplink data channel.

27. The method of claim 25, further comprising:
obtaining, in a second uplink data channel based at least in part on the second uplink data channel being associated with the priority level, a copy of the uplink control information multiplexed with second data.

28. The method of claim 25, wherein the control message indicates a second priority level, the method further comprising:
obtaining, in a second uplink data channel based at least in part on the second priority level being associated with the second uplink data channel, a copy of the uplink control information that is multiplexed with second uplink data associated with the second uplink data channel.

29. The method of claim 28, further comprising:
combining the uplink control information with the copy of the uplink control information, wherein decoding the uplink control information comprises decoding the combination of the uplink control information and the copy of the uplink control information.

30. The method of claim 25, further comprising:
outputting a second control message that is associated with a second uplink control channel and that indicates the priority level; and
obtaining, based at least in part on the control message and the second control message indicating the same priority level, the uplink control information multiplexed with second uplink control information that is associated with the second uplink control channel.
